(19) United States
(12) Patent Application Publication
(10) Pub. No.: US 2013/0244078 A1
(43) Pub. Date: Sep. 19, 2013

(54) RADIATING APPARATUS FOR BATTERY CELL USING INTERFACE PLATE

(71) Applicants: Jin Woo Kwak, Suwon (KR); Kyong Hwa Song, Seoul (KR); Han Saem Lee, Ansan (KR); You Sung Moon, Uiwang (KR); Byung Sam Choi, Suwon (KR)

(72) Inventors: Jin Woo Kwak, Suwon (KR); Kyong Hwa Song, Seoul (KR); Han Saem Lee, Ansan (KR); You Sung Moon, Uiwang (KR); Byung Sam Choi, Suwon (KR)

(73) Assignee: HYUNDAI MOTOR COMPANY, Seoul (KR)

(21) Appl. No.: 13/540,863

(22) Filed: Jul. 3, 2012

(30) Foreign Application Priority Data
Mar. 19, 2012 (KR) 10-2012-0027468

(51) Int. Cl. H01M 10/50

(52) U.S. Cl. 429/120

(57) ABSTRACT

Disclosed is a radiating apparatus for a battery cell which uses an interface plate which can effectively radiate heat accumulated in the battery. In particular, an aluminum-elastomer structure composite material with excellent thermal conductivity is used as the interface plate. Further, the radiating apparatus includes an outer case having cooling channels, through which cooling air passes to discharge heat generated from a battery cell, and a battery cell and an interface plate which are provided within the outer case and which are alternately stacked to make surface-contact with each other. The interface plate advantageously discharges the heat accumulated in the battery cell using aluminum-elastomer structure composite material.

### CROSS-REFERENCE TO RELATED APPLICATION

This application claims under 35 U.S.C. §119(a) the benefit of Korean Patent Application No. 10-2012-0027468 filed on Mar. 19, 2012, the entire contents of which are incorporated herein by reference.

### BACKGROUND

(a) Technical Field

The present disclosure relates to a radiating apparatus for a battery cell using an interface plate. More particularly, it relates to a radiating apparatus for a battery cell using an interface plate capable of efficiently radiating heat generated from the battery cell.

(b) Background Art

Generally, a battery cell that is included in a battery system for an electric vehicle and for a hybrid vehicle includes a battery part and a pouch-type case with a space for receiving the battery part. The battery part is normally assembled by disposing an anode plate, a separator and a cathode plate consecutively and then winding them in a particular direction or by stacking a number of the anode plates, the separators and the cathode plates to have multiple-layered structure.

The pouch-type case in the form of a film has the excellent flexibility which allows the case to be bent in various directions. Material for the battery case and a housing is typically formed by filling a plastic substrate, such as PC+ABS, PA, PP, etc., with flame-retardant filler, such as mineral filler by the amount of 20˜30 weight %, so that the case and housing have a certain degree of flame-retardancy, chemical resistance, insulating properties and durability.

However, these conventional batteries do not efficiently discharge and diffuse heat faster than the heat is generated by the battery cells due to the high degree of power, speed and repetitive charging that occurs in each of the battery cells of an electric or hybrid vehicle. Accordingly, thermal runaway may occur as a result. Thermal runaway refers to a situation where an increase in temperature changes the conditions in a way that causes a further increase in temperature, often leading to destruction in the object. In other words, the term “thermal runaway” is used whenever a process is accelerated by increased temperature, in turn releasing energy that further increases temperature.

In this instance, a localized temperature difference and a high temperature may occur and efficiency and stability of the battery may as a result be deteriorated because the material used for the battery case and the housing does not have a heat-radiant function.

When charging and discharging a lithium secondary battery, lithium ions are intercalated and de-intercalated as electrode material, and thus the pouch-type battery cell varies in volume according to charging and discharging voltages as illustrated in FIG. 1A.

As stated herein-above, the damage to the separator due to the expansion of an electrode plate in the battery cell may result an increase in voltage and a decrease in final battery capacity, along with an increase in internal resistance. Additionally, when the volume expansion in the battery cell is severe, the case may also be damaged, so that there is risk of electrolyte-leakage and gas-outflow. Accordingly, when a pouch-type battery pack module which has a number of battery cells stacked therein is used, the volume expansion in the battery cell, the gas outflow or an explosion may lead to direct damage to an adjacent cell.

One solution to this problem is to form cooling channels between the stacked battery cells, as illustrated in FIG. 2 a conventional battery system has cooling channels 2 formed between the stacked battery cells 1 to discharge the heat generated from the battery cell so that the cooling air can pass through the cooling channels 2.

When battery cell expansion due to the intercalation and de-intercalation of lithium ion occurs, the cooling channels 2 formed between the battery cell modules in the battery pack unit are reduced to decrease the cooling effect, and the temperature increase in the adjacent cell 1 accelerates an exothermic phenomenon between adjacent battery cells which may cause a significant deterioration in battery performance.

However, in order to improve the efficiency of heat radiant properties in the cooling channel between the battery cells in the conventional system, a space for the cooling channel is enlarged or the size and capacity of a cooling fan is increased, which leads to increase in volume or weight of the entire battery system.

KR 10-1029021 discloses a cell module, wherein a number of battery cells are stacked in order to improve the heat radiant properties of the battery cells. The disclosed cell module includes a cooling system wherein refrigerant flows through spaced gaps (channels) between the battery cells for performing a contact-type cooling. Each channel between the battery cells is inclined at a predetermined angle with respect to a proceeding direction of the refrigerant at an inlet of the channel. Also, with increase in the contract rate of the refrigerant to the battery cell and with generation of many vortexes, the current speed-gradient of the refrigerant in the channels between the unit cells is removed to attain high efficiency of the cooling.

Normally, in order to enhance the heat-radiant efficiency in the battery cell module, a flow rate is increased or current speed is raised by enlarging the space in the channel. In case of the disclosed KR patent mentioned above, the heat-radiant efficiency may be effectively enhanced by means of the angle adjustment of the flow channel without any increase in size and capacity of the cooling fan. However, the size increase of the overall module is unavoidably expected for the angle adjustment. Thus, the overall module is larger than the conventional designs. Also, the improvement in the energy density per unit volume is restricted in view of the fact that the channel space between the battery cells should maintain a distance which is equal to or greater than a certain length.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a radiating apparatus for a battery cell using an interface plate which can effectively radiate heat accumulated in the battery. In particular, an aluminum-elastomer structure composite material with excellent thermal conductivity is used as the interface plate.

Another object of the present invention is to provide a radiating apparatus for a battery cell using an interface plate which can counteract volume change of the battery occurring when charging and discharging the battery by inserting an aluminum-elastomer structure composite material between layers of a pouch type-battery cell to thereby use the elasticity of elastomer to allow for volumetric change in the cell.

Another object of the present invention is to provide a radiating apparatus for a battery cell using an interface plate which can enhance energy density in comparison to a conventional battery cell with the same volume by decreasing the cell gap without any channel space between the battery cells.

In one aspect, the present invention provides a radiating apparatus for a battery cell using an interface plate. The radiating apparatus includes an outer case having cooling channels, through which cooling air passes to thereby discharge heat generated from a battery cell. Additionally, a battery cell and an interface plate are provided in the outer case and are alternately stacked to make surface contact with each other. The interface plate discharges the heat accumulated in the battery cell using aluminum-elastomer structure composite material.

In an exemplary embodiment, the interface plate has protrusions that are formed to be longer than the length of the battery cell in either lateral direction. The cooling channel is formed between the protrusions, so that the cooling air moving through the cooling channel can discharge the heat generated in the battery cell.

In another exemplary embodiment, the outer case has inlet ports formed at both ends of a front surface of the outer case and outlet ports formed at both ends of a rear surface of the outer case. The cooling air from the outside is introduced into the inlet ports and is discharged out of the outlet ports.

In still another exemplary embodiment, the interface plate includes a heat conducting member stacked onto the battery cell to radiate the heat generated from the battery cell to the outside and, an elastic layer formed to enclose outer surface of the heat conducting member and configured to counteract volumetric change of the battery cell due to its elasticity.

In yet another exemplary embodiment, the heat conducting member is made of aluminum material with excellent thermal conductivity.

In some exemplary embodiments, the elastic layer is produced by an over-molding with engineering plastic material containing heat-radiant filler, which includes one or more mixtures selected from graphite, boron nitride, aluminum nitride and carbon black, so that the heat generated in the battery cell is transferred to the heat conducting member. The heat conducting member is formed with protrusions at both ends thereof to protrude beyond the ends of the battery cell in a lengthwise direction, and the elastic layer is formed over the heat conducting member except for the protrusions.

In another further exemplary embodiment, the protrusions are spaced from a wall face of the outer case at a certain distance, so that the temperature difference between the battery cells decreases so that a fluid can flow between the cooling channels. The protrusions are installed to contact a wall face of the outer case, so that the heat-radiant efficiency in each of battery cell increases.

These protrusions may include concave-convex portions, so that the heat-radiant property is improved so that the concave-convex portions can generate a turbulent flow while the cooling air travels through the cooling channels.

The radiating apparatus for battery cell using an interface plate according to the present invention has advantages as listed herein below.

First, the interface plates made of aluminum-elastomer with excellent thermal conductivity is disposed between the battery cells. Both ends of the interface plate protrude to be longer than the battery cell and a cooling channel is formed between protrusions. Heat is transferred to the cooling channel so that the heat generated from each battery cell can be transferred through each interface plate, and the cooling air flowing through the cooling channel efficiently discharges the heat generated from each battery cells, thereby preventing thermal runaway which often occurs in the prior art.

Second, the structure composite material for use in the interface plate is formed by over-molding thermoplastic elastomer onto the aluminum plate, so that the elasticity of elastomer is used to positively counteract the volumetric change of the battery cell generated from the heat of the battery cell.

Third, the interface plate is intercalated between the battery cells without any additional channel space, so that a distance between the cells may be reduced to thereby enhance the energy density in comparison to with a battery cell of the conventional art with the same volume.

Fourth, a concave-convex portion is formed on the protrusion of the interface plate and turbulent flow is generated by the concave-convex portion while the cooling air passes between the protrusions, thereby avoiding the fluid speed gradient that deteriorates the discharging efficiency. As the cooling air coming through the inlet port has low flow rate and low current speed, the use of the convex-concave portion addresses problems associated with noise and heat generation due to friction.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1A-B is a graph showing a thickness change in the battery cell according to a charging voltage and a discharging voltage in the conventional art;

FIG. 2 is a cross-sectional view of an air cooling type-radiating apparatus for the battery cell according the conventional art;

FIG. 3 is an exploded view of a radiating apparatus for a battery cell with open type-cooling channels according to an embodiment of the present invention;

FIG. 4 is an assembled state-view of FIG. 3;

FIG. 5 is a top view of FIG. 4;

FIG. 6 is a front view of FIG. 4;

FIG. 7 is a perspective view of an interface plate illustrated in FIG. 3;

FIG. 8 is an exploded view of a radiating apparatus for a battery cell with a closed-type cooling channel according to another embodiment of the present invention;

FIG. 9 is an assembled state-view of FIG. 8;

FIG. 10 is a top view of FIG. 9;

FIG. 11 is a front view of FIG. 9;

FIG. 12 is a perspective view illustrating a concave-convex configuration of the interface plate; and

FIG. 13 is a schematic view illustrating turbulence occurring due to the concave-convex configuration of FIG. 12.

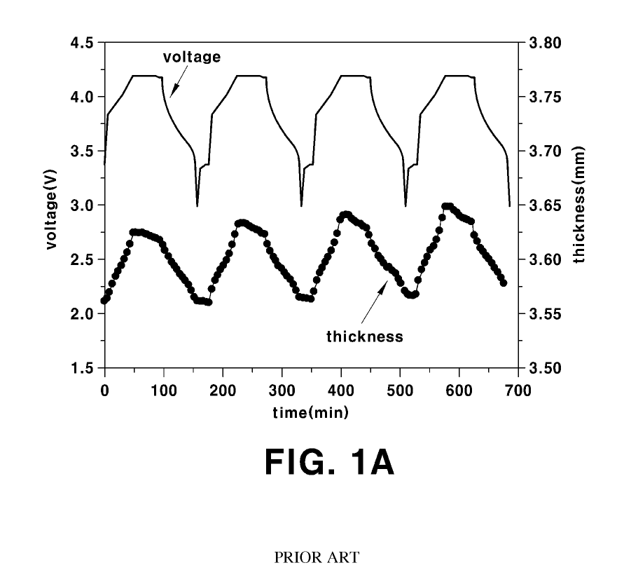

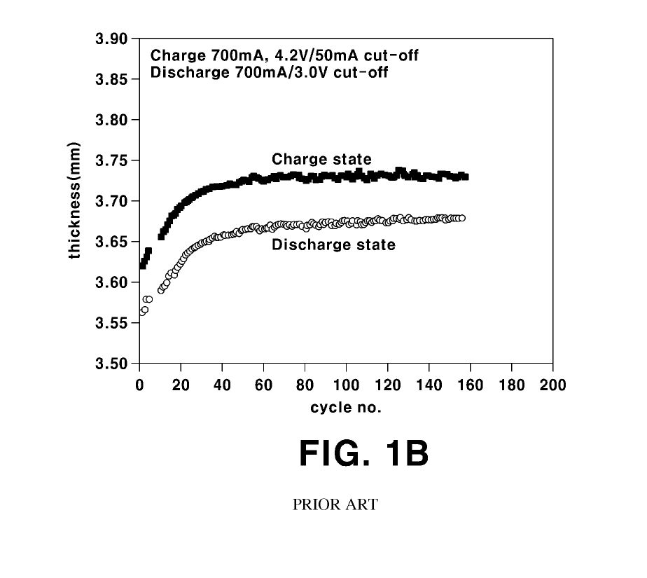

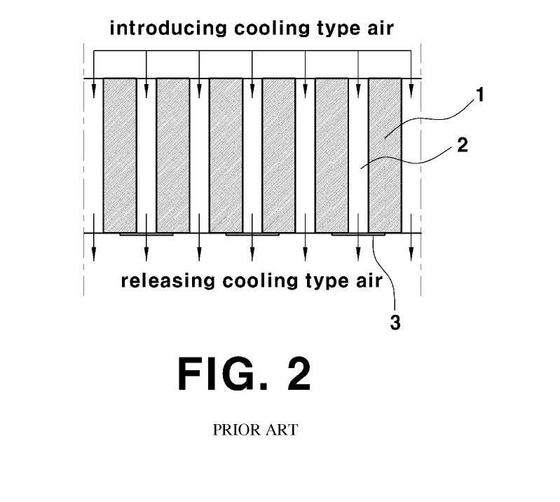

Reference numerals set forth in the Drawings includes reference to the following elements as further discussed below:¹

10: outer case

10a: inlet port

10b. outlet port

11. heat conducting member

11a. protrusion

11b. concave-convex portion

12. elastic layer

13. Interface plate

14. battery cell

15. body

16. upper cover

17. cooling channel

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other features of the invention are discussed infra.

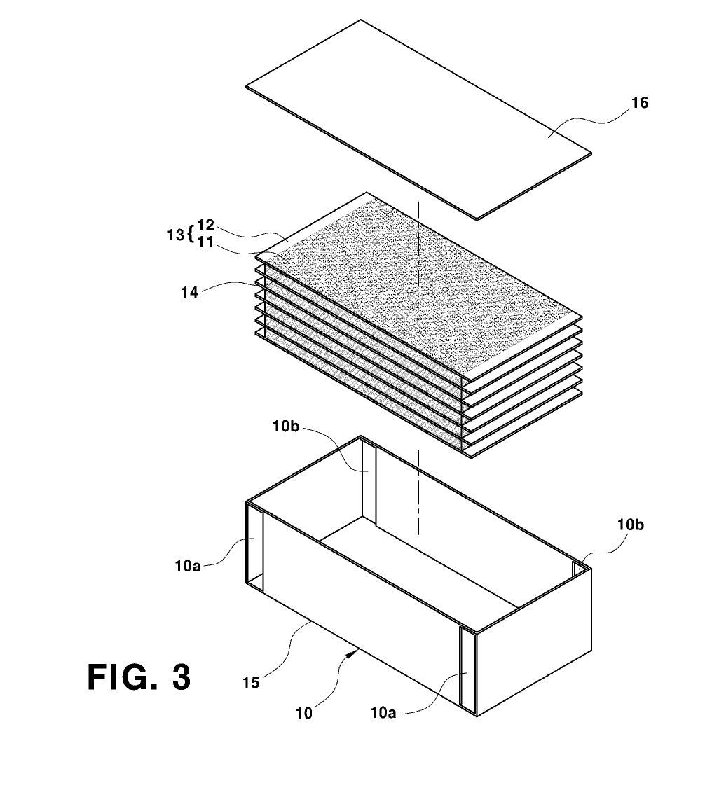

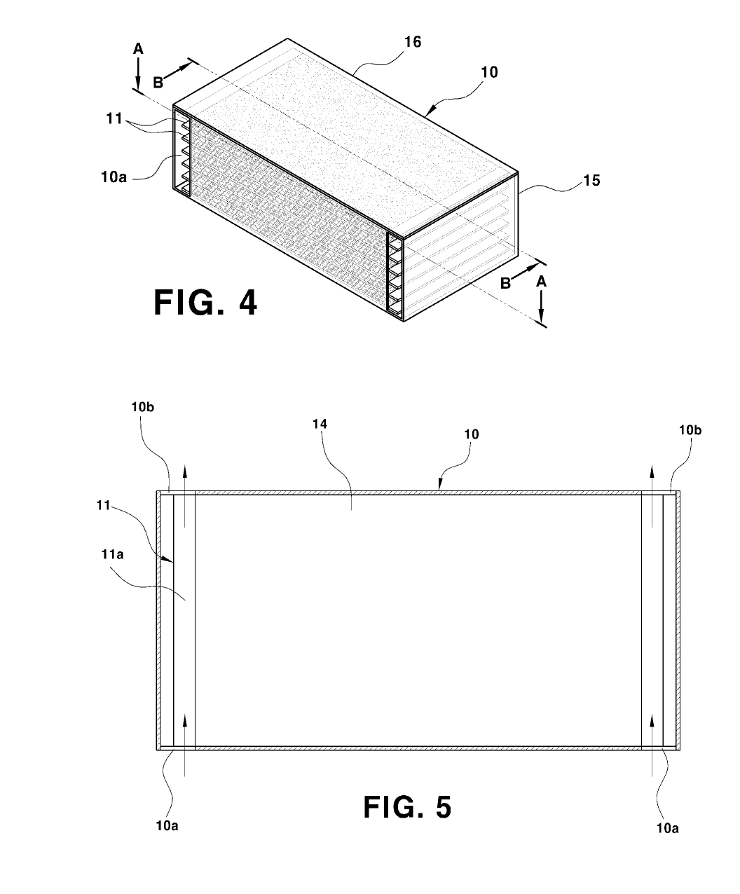

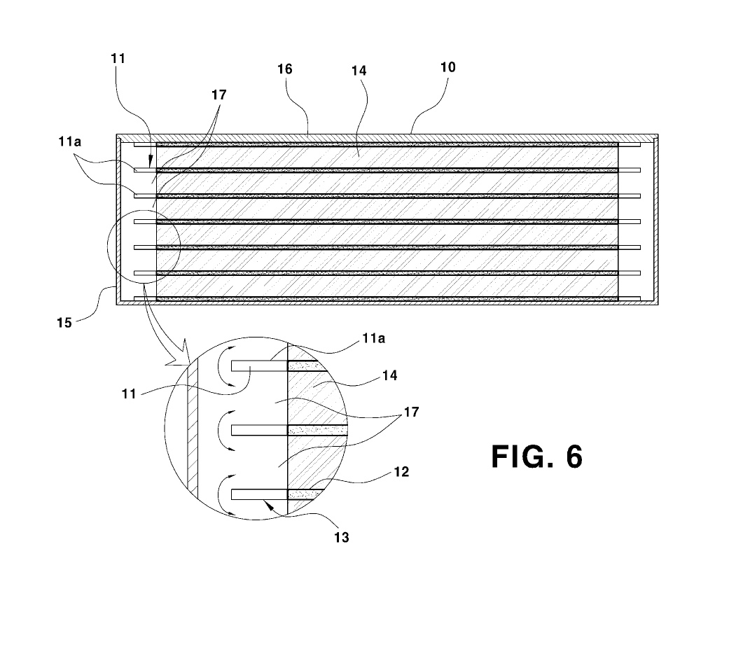

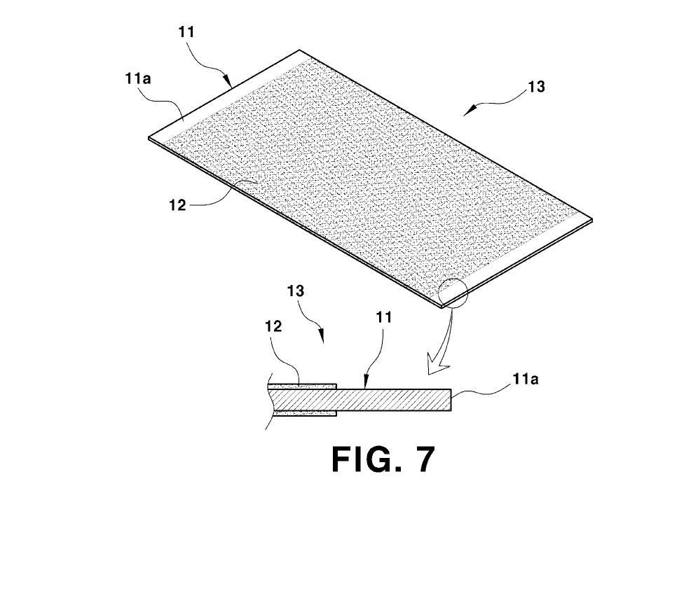

FIG. 3 is an exploded view of a radiating apparatus for a battery cell with open type-cooling channels according to an embodiment of the present invention. FIG. 4 is an assembled state-view of FIG. 3. FIG. 5 is a top view of FIG. 4. FIG. 6 is a front view of FIG. 4. FIG. 7 is a perspective view of an interface plate illustrated in FIG. 3.

The present invention is related to the radiating apparatus for the battery cell using an interface plate 13 which can effectively radiate heat accumulated in the battery, wherein aluminum-elastomer structure composite material with excellent thermal conductivity is used as the interface plate.

The radiating apparatus for the battery cell according to an embodiment of the present invention may effectively radiate heat accumulated in a battery cell 14 by forming cooling channels 17 at both ends of the battery cell 14. The radiating apparatus for the battery cell includes: the battery cells 14 stacked to form a multi-layered structure; the interface plates 13 interposed between the battery cells 14; and an outer case 10 enclosing the battery cells 14 and the interface plates 13. The battery cell 14 may be preferably a pouch type secondary battery, wherein two electrodes, a separator and electrolyte are enclosed and sealed in a film type pouch.

As the pouch type secondary cell, lithium secondary cells that have a high energy density per a unit weight and enable rapid-charging may be connected in series for use, so that the cells can be applied to the battery system of a high-powered electric vehicle and a hybrid vehicle.

The interface plate 13 includes a planar heat conducting member 11 and an elastic layer 12. The planar heat conducting member is made of aluminum material having a certain degree of thermal conductivity. The elastic layer 12 encloses the heat conducting member 11 so as to offer elasticity to the interface plate 13.

The heat conducting member 11 has an area slightly larger than that of the battery cell (14). For instance, when viewing the heat conducting member 11 on a plane, the heat conducting member 11 is slightly longer than the battery cell 14 in either lateral direction (e.g., by 6 mm, respectively) and in a widthwise direction (e.g., by 2 mm, respectively).

Accordingly, protrusions 11a are respectively formed at both ends of the heat conducting member 11 to thereby protrude from both ends of the battery 14 with a certain length (e.g. about 6 mm). The protrusions 11a are stacked in an upward-and-downward direction at a certain interval that is equal to sum of the thicknesses of the battery cell 14 and of the elastic layer 12 to thereby form a cooling channel 17 at both ends of the battery cell 14. Cooling air from outside may pass through the cooling channel 17 to discharge the heat accumulated in the battery cell 14 outside via cooling air.

The elastic layer 12 may preferably be made of composite material (e.g., with a thermal conductivity of about 10˜20 W/mK), which is obtained by combining graphite with a thermal conductivity of about 100˜200 W/mK with thermoplastic elastomer material. The composite material may be over-molded onto the aluminum heat conducting member 11 to be integrally formed therewith, so that the structure composite material (the interface plate 13) is attained.

The elastic layer 12 may be formed over the surface covering the battery except for the protrusion 11a of the heat conducting member 11, so that it can counteract the volumetric change occurring while charging and discharging the battery cell 14.

The protrusions 11a of the heat conducting member 11 have nothing to do with the volumetric change of the battery cell 14 and only serve as a cooling function by defining the cooling channels for passing the cooling air therethrough. Accordingly, it is unnecessary to cover the protrusions with the elastic layer 12, and it can maximize the efficiency of heat-convection by means of the cooling air passing through the cooling channels 17 between the protrusions 11a.

For example, when the volume of the battery cell 14 increases, the elastic layer 12 may absorb the expansion pressure of the battery cell 14. This prevents damage to the battery cell case. Also, since no deformation of the heat conducting member 11 occurs due to the volumetric change of the battery cell 14, the adjacent cooling channels 17 formed between the protrusions 11a of the heat conducting member 11 are not affected there-from, and thus the exemplary embodiment of the present invention can prevent deterioration of the cooling effect due to the reduction of the adjacent cooling channels 17.

Additionally, in the exemplary embodiment of the present invention, there is no interface gap between the cell and the elastomer material due to the gripping properties of the thermoplastic elastomer material, and thus it is possible to obtain efficient heat transfer to the aluminum heat conducting member 11 through the elastomer material.

In other words, the heat generated in the battery cell 14 is transferred to the aluminum heat conducting member 11 through the elastomer material, and then the heat is transferred to the protrusion 11a corresponding to an edge of the aluminum heat conducting member 11 according to the temperature gradient (i.e., from the higher temperature to the lower temperature). Thereafter, the heat is discharged via the cooling air passing through the cooling channels 17 between the protrusions 11a, so that the heat is radiated outside.

In case of the radiating apparatus for the battery cell in the prior art, a certain interval about 3˜5 mm is preferably maintained so as to form a channel between pouch cells, and thus the degree of freedom in design is significantly restricted. In the present invention, however, the battery cell 14 and the interface plate 13 reduces the interval between the cells below 3 mm without any additional gap therebetween. Accordingly, it is possible to improve the energy density in view of the same volume.

The outer case 10 may be a hard case made of a rigid material in order to protect the battery cell 14 against impact from a foreign object. The outer case 10 may include a main body 15 and an upper cover 16 covering an upper part of the main body 15, so that the outer case 10 can enclose the peripheral surface of the stacked battery cells 14.

The outer case 10 may be made of a heat radiant filler with excellent thermal conductivity. For instance, it is made of graphite, boron nitride, aluminum nitride and engineering plastic containing carbon black, etc.

For example, inlet ports 10a are formed at both ends of a front surface of the outer case 10 and outlet ports 10b are formed at both ends of a rear surface of the outer case 10. Accordingly, the cooling air from the outside flows into the outer case 10 through the inlet ports 10a, passes through the cooling channels 17 formed between the protrusions 11a of the interface plate 13, and then discharges the heat of the battery cells 14 through the outlet ports 10b.

Here, according to an embodiment of the present invention, a space is provided between a vertical wall face of the outer case 10 and an end of the protrusion 11a of the interface plate 13 (the open-type cooling channel 17), so that fluid can move upward and downward between the cooling channels 17 defined above and below the protrusion 11a. Accordingly, the temperature difference between the battery cells 14 may decrease to thereby attain stability.

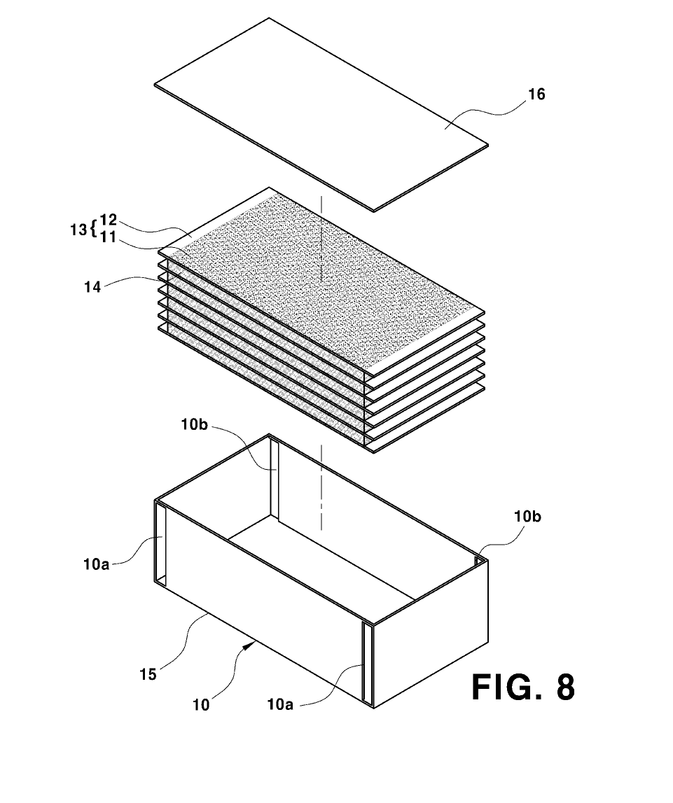

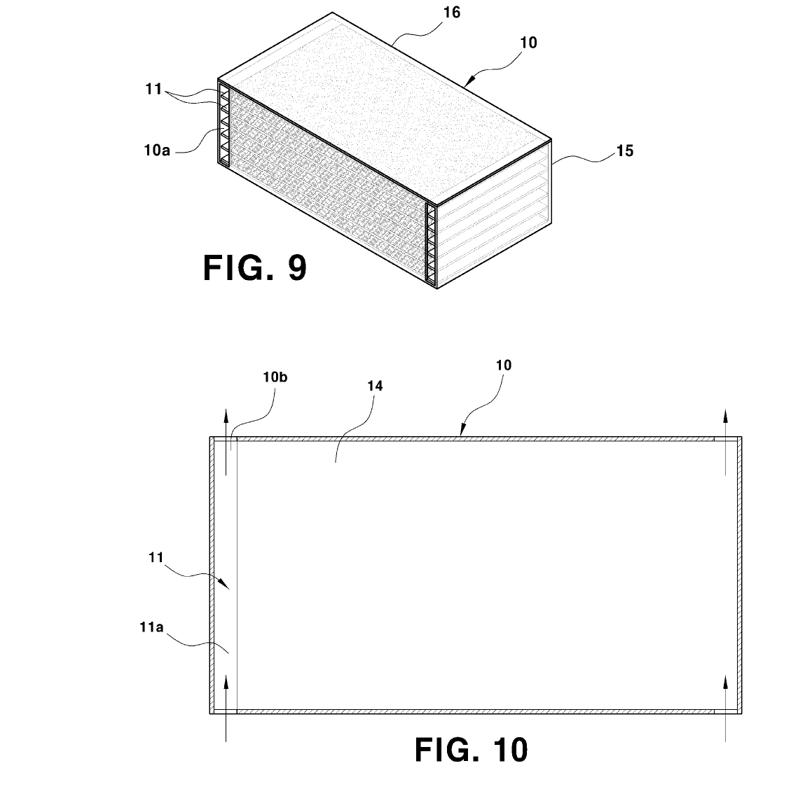

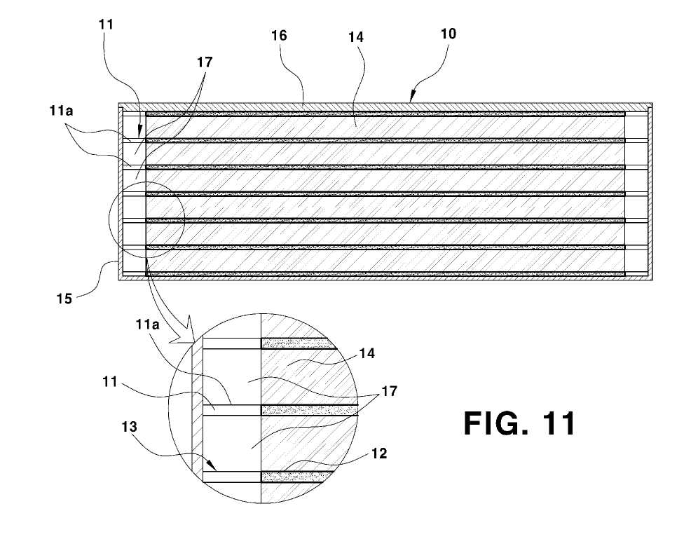

FIG. 8 is an exploded view of a radiating apparatus for a battery cell with a closed-type cooling channel according to another embodiment of the present invention. FIG. 9 is an assembled state-view of FIG. 8. FIG. 10 is a top view of FIG. 9. FIG. 11 is a front view of FIG. 9.

According to another embodiment of the present invention, the protrusion 11a of the interface plate 13 abuts the vertical wall face of the outer case 10 (the closed type cooling channel 17) to form a closed cooling channel 17, thereby, improving the heat-radiant efficiency of each battery cell 14. Accordingly, the space between the protrusion 11a and the wall face of the outer case 10 may be defined to be about 1˜3 mm, so that the stability and the efficiency in the heat radiation can be met at the same time.

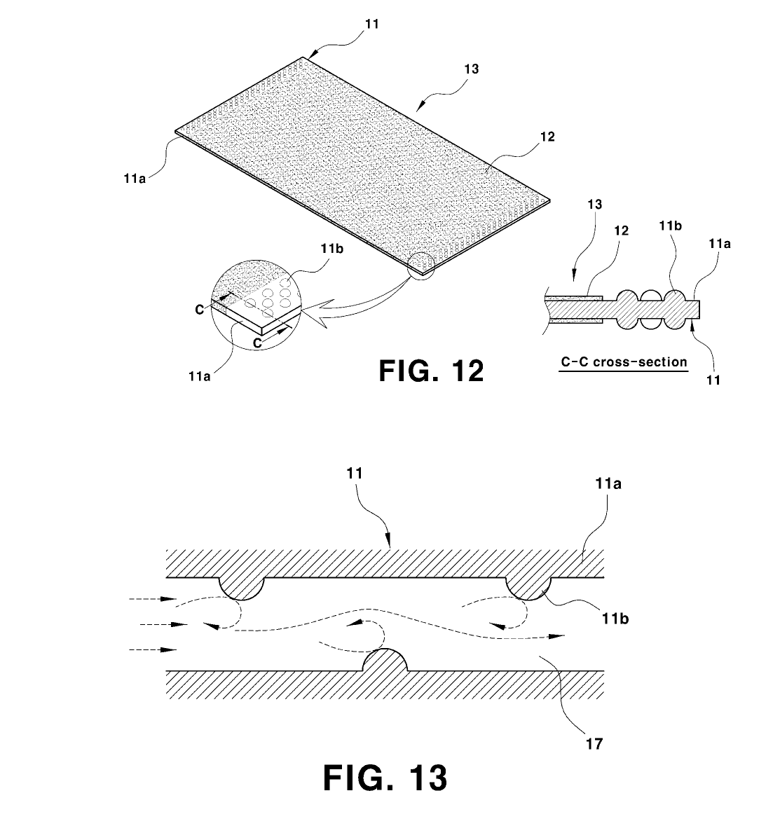

FIG. 12 is the perspective view illustrating the concave-convex configuration of the interface plate; and FIG. 13 is the schematic view illustrating the turbulence occurring due to the concave-convex configuration of FIG. 12.

Upper and lower surfaces of the protrusion 11a may be formed with a concave-convex portion 11b in the form of a semi-sphere, so that turbulent flow and vortex flow are generated due to the concave-convex portion 11b while the cooling air travels along the cooling channel 17. Accordingly, it is possible to enhance the heat-radiant properties.

With the generation of the turbulent flow by the concave-convex configuration of the protrusion 11a, it is possible to prevent the current speed-gradient which deteriorates the heat radiant efficiency. When using the concave-convex portion 11b of the present invention, problems, such as the noise due to friction and the heat generation can be solved because the flow rate and current speed are low.

When the cooling air flows through the cooling channels 17 as stated above, the radius of curvature of the concave-convex portion 11b may be properly adjusted in order to obtain the efficient formation of the turbulent flow while minimizing the flow resistance. Also, the concave-convex portions 11b may be formed to have a staggered arrangement on the upper and lower surfaces of the protrusion 11b in order to ensure the space for air flow.

Herein below, the present invention will be more specifically detailed with reference to an embodiment, but the present invention is not restricted by the embodiment below.

### EXAMPLES

The following examples illustrate the invention and are not intended to limit the same. A method for manufacturing the radiating apparatus for the battery cell 14 will be detailed.

With the use of ethanol and acetone, dust and organic pollutant are removed from a surface of an aluminum plate in the shape of a sheet (e.g., about 290 mm×156 mm×1 mm (W×L×H)). Thereafter, the aluminum plate is pre-etched in 5% NaOH aqueous solution for a period of 4˜6 minutes, and then it is dipped in a bath containing 30% HNO₃. Then, the aluminum plate is cleaned by running water (pre-treatment process of the surface).

Thereafter, thermoplastic elastomer material (styrene-ethylene/butadiene-styrene, SEBS) containing graphite heat-radiant filler by about 30˜40 wt % is over-molded onto the surface-treated aluminum plate to thereby integrate them, so that the interface plate 13 is produced.

Here, the thermal conductivity of the SEBS composite material is preferably equal to or be greater than about 1 W/mK in the thickness direction (or the z direction). Also, both end portions of the aluminum plate are left untouched by about 10˜30 mm to thereby form the cooling channel 17 for heat radiation.

The cooling air is introduced through the inlet ports 10a of the outer case 10 in a direction perpendicular to a stack direction of the battery cells and, the cooling air passes the cooling channels 17, each of which is surrounded by the aluminum protrusions 11a uncovered by resin and the wall face of the outer case 10.

The thickness of the SEBS composite material coated on the aluminum plate is preferably sufficiently thin for the sake of the efficient heat transfer. At the same time, the thickness is preferably adjusted to have sufficient elasticity to improve the gripping property and to counteract the volume change (e.g., the thickness of 0.3 mm˜0.6 mm)

The outer case 10 may be made of polyamide 45 containing graphite heat-radiant filler by about 30˜50 wt % and has a rectangular parallelepiped shape with the cooling channel inlet and outlet ports for the cooling air, which are located at right and left sides of the front and rear surfaces.

The cooling channels 17 maintain the space between the end of the aluminum protrusion 11a and the wall face of the outer case 10 by about 1˜3 mm to thereby satisfy the stability and the efficiency of the heat-radiant properties at the same time.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A radiating apparatus for a battery cell using an interface plate, the radiating apparatus comprising:
an outer case having cooling channels, through which cooling air passes to discharge heat generated from the battery cell; and
an interface plate provided within the outer case and alternately stacked between the battery cell an adjacent battery cell and orientated to interface with each adjacent battery cell;
wherein said interface plate discharges the heat accumulated in each battery cell using aluminum-elastomer structure composite material.

2. A radiating apparatus for a battery cell using an interface plate according to claim 1, wherein said interface plate has protrusions that are formed to be longer than a length of the battery cell in either lateral direction, and wherein the cooling channel is formed between said protrusions so that the cooling air moving through said cooling channel discharges the heat generated in the battery cell.

3. A radiating apparatus for a battery cell using an interface plate according to claim 1, wherein said outer case has inlet ports formed at both ends of a front face and outlet ports formed at both ends of a rear face, and wherein the cooling air from the outside is introduced into the inlet ports and is discharged out of the outlet ports.

4. A radiating apparatus for a battery cell using an interface plate according to claim 1, wherein said interface plate comprises:
a heat conducting member stacked onto the battery cell to thereby radiate the heat generated from the battery cell to the outside; and,
an elastic layer formed to enclose outer surface of said heat conducting member and configured to counteract volumetric change of the battery cell due to elasticity.

5. A radiating apparatus for a battery cell using an interface plate according to claim 4, wherein said heat conducting member is made of aluminum material with at least a predetermined level of thermal conductivity.

6. A radiating apparatus for a battery cell using an interface plate according to claim 4, wherein said elastic layer is produced by an over-molding with a composite material having a thermal conductivity of about 10˜20 W/mK, which is obtained by combining graphite having a thermal conductivity of about 100˜200 W/mK with thermoplastic elastomer material, so that the interface plate transfers the heat generated in the battery cell to the heat conducting member.

7. A radiating apparatus for a battery cell using an interface plate according to claim 4, wherein said heat conducting member 11 is formed with protrusions at both ends thereof to protrude beyond ends of the battery cell in a lengthwise direction, and wherein said elastic layer is formed over the heat conducting member except for the protrusions.

8. A radiating apparatus for a battery cell using an interface plate according to claim 2, wherein said protrusions are spaced from a wall face of the outer case at a certain distance, so that a temperature difference between the battery cells decreases so that fluid flows between the cooling channels.

9. A radiating apparatus for a battery cell using an interface plate according to claim 2, wherein said protrusions are installed to contact a wall face of the outer case, so that the heat-radiant efficiency in the battery cell increases.

10. A radiating apparatus for a battery cell using an interface plate according to claim 2, wherein said protrusions include concave-convex portions, so that the heat-radiant property is improved so that said concave-convex portions generate turbulent flow while the cooling air travels through the cooling channels.
